(19) United States
(12) Patent Application Publication
(10) Pub. No.: US 2019/0261041 A1
(43) Pub. Date: Aug. 22, 2019

(54) Media Processing and Collaboration Platform

(71) Applicant: OurJamz Inc., San Jose, CA (US)

(72) Inventors: Erik R. Swenson, San Jose, CA (US); Michael Guzewicz, Campbell, CA (US); Vijay Kumar, Sunnyvale, CA (US); Arne Hurty, Burlingame, CA (US)

(21) Appl. No.: 16/279,861

(22) Filed: Feb. 19, 2019

Related U.S. Application Data
(60) Provisional application No. 62/632,357, filed on Feb. 19, 2018.

(51) Int. Cl. H04N 21/2743; H04N 21/239; H04N 21/6377; H04N 21/242; H04N 21/2368; H04N 21/8547; H04N 21/8549; G11B 27/031

(52) U.S. Cl. CPC H04N 21/2743; H04N 21/2393; H04N 21/6377; G11B 27/031; H04N 21/2368; H04N 21/8547; H04N 21/8549; H04N 21/242

(57) ABSTRACT

A system and a method are disclosed for providing a collaborative platform for audio and video media processing. In an embodiment, a system enables remote real-time processing for audio and video user commands that enables, for example, network or cloud centric audio and/or video collaborative processing. In an embodiment, a system generates static video images and thumbnail videos for uploaded video data, the static video images and thumbnails videos used to summarize the video data. In an embodiment, a system generates audio thumbnails for uploaded audio data, the audio thumbnail used to summarize the audio data. In an embodiment, a system implements distributable, modular processing nodes to perform actions for the collaborative media system. In an embodiment, a system provides a grid placement interface for overlaying one or more video and audio files during processing. In an embodiment, a system identifies song structures in audio data for use during processing.

### CROSS REFERENCE TO RELATED APPLICATIONS

This application claims the benefit of U.S. Provisional Application No. 62/632,357, filed Feb. 19, 2018, which is incorporated by reference in its entirety.

### TECHNICAL FIELD

The disclosure generally relates to the field of audio and video media processing, and more specifically to providing a collaborative platform for real-time audio and video media processing.

### BACKGROUND

Audio and video media processing tools and applications allow users to access, create, and modify audio and video data to create audio and visual content. Content creators may upload, record, or access previously stored audio and video data and apply processing tools to compile and modify the audio and video data. For example, content creators apply tools to overlay audio data to video data, compile multiple audio soundtracks, modify volume and timing of audio and video data, cut audio and video data, and perform other processing actions to generate a desired audio and video file.

Conventional audio and video media processing applications are designed for single-user experiences. Accordingly, audio and video data and media processing tools are locally hosted on a content creator's device. However, conventional audio and video media processing applications make collaborative projects difficult. Typically, all data and processing tools are locally stored for each content creator. Thus, accessing shared audio and video data requires content creators to manually exchange audio and video files. For extensive projects or projects wherein data is exchanged repeatedly, this inability to easily share files becomes burdensome to content creators.

Additional difficulties can arise due to differences in client software, file formatting, and the like. Audio and video media processing applications used by content creators may differ in formatting and software capabilities based on a number of factors, such as different applications, different audio and video file formatting, different operating systems, and the like. These differences may impact an application's ability to read, access, or process received audio or video files.

Conventional audio and video media processing applications may additionally encounter problems due to limited storage space. Processing applications including plug-ins and other tools, audio files, and video files require large file sizes. Accordingly, extensive projects can cause data storage issues on client devices.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG. 1 is a block diagram of an example system environment for a collaborative media system, according to an embodiment.

FIG. 2 is a block diagram of an example architecture of the collaborative media system, according to an embodiment.

FIG. 3 is a block diagram of an example architecture of the RTC server, according to an embodiment.

FIGS. 4A-4B are a transaction diagram illustrating example interactions between a client device, RTC server, audio server, and video server, according to an embodiment.

FIG. 5 is a flowchart illustrating an example method for remote processing audio and video user commands, according to an embodiment.

FIG. 6 is a block diagram of an example architecture of the thumbnail server, according to an embodiment.

FIG. 7 is an illustration of an example process for generating thumbnails for video data, according to an embodiment.

FIG. 8 is an illustration of an example process for generating thumbnails for audio data, according to an embodiment.

FIGS. 9A-9B are flowcharts illustrating example methods for generating thumbnails for audio and video data, according to an embodiment.

FIG. 10 is an illustration of an example tree structure of an audio processing engine, according to an embodiment.

FIGS. 11A-11B are illustrations of example user interfaces for enabling users to place video and audio data in a grid layout, according to an embodiment.

FIGS. 12A-12B are illustrations of example user interfaces for enabling users to identify a song structure for audio data and to apply the identified song structure during processing, according to an embodiment.

FIG. 13 is a block diagram illustrating components of an example machine able to read instructions from a machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system, method and computer readable storage medium includes a collaborative media system. The collaborative media system platform is configured to allow content creators to access, modify, and store audio and video data remotely and in real-time. By allowing real-time frame-by-frame processing of audio and video data hosted remotely, a network-centric (or network cloud) collaborative media system addresses problems experienced in conventional (e.g., desktop) media processing applications. For example, the media processing and collaboration platform enables content creators to collaborate with other users to create content without limitations of file formatting, data storage, data processing speed, and other similar problems.

One embodiment of a disclosed system enables remote processing for audio and video user commands. The disclosed system receives a user command from a client device identifying an action to be performed in real-time. The system determines a command type of the user command, the command type describing a media type (e.g., audio, video, etc.) associated with the action. Based on the determined command type, the system identifies a server to perform the action. For example, the identified server is an audio server for an audio command. In another example, the identified server is a video server for a video command. The system transmits the user command to the identified server for processing and retrieves one or more outputs associated with the user command. The system synchronizes the one or more outputs and transmits the synchronized outputs to the client device.

One embodiment of a disclosed system enables generating a thumbnail for video data uploaded to a collaborative media system. The system receives uploaded video data from a client device including one or more frames associated with timestamps. Responsive to receiving the uploaded video data, the system generates a static video image from a frame of the video data. In one example, the static video image is generated by selecting a set of frames from the one or more frames of the video data, the selecting performed at non-contiguous time intervals based on the length of the video data. The system selects a subset of frames from the selected set of frames, the subset of frames associated with timestamps based on a threshold amount of time from the start and end of the video data. For each frame of the subset of frames, the system determines a bit size. Based on the determined bit sizes, the system selects a frame for use in generating the static video image. Responsive to receiving the uploaded video data, the system additionally generates a thumbnail video. In one example, the thumbnail video is generated by selecting a subset of frames from the one or more frames of the video data, the selection performed at a series of time intervals. The system combines the selected subset of frames to create the thumbnail video. The system stores the static video image and the thumbnail video in association with the uploaded video data.

One embodiment of a disclosed system enables generating a thumbnail for uploaded audio data uploaded to a collaborative media system. The system receives uploaded audio data from a client device. Responsive to receiving the uploaded audio data, the system generates an audio thumbnail from a sampling of the audio data. In one example, the audio thumbnail is generated by identifying blocks of audio data corresponding to a time interval (e.g., 50 milliseconds). For each block of audio data, the system measures a maximum amplitude and a minimum amplitude. The system stores the maximum and minimum amplitude for each block of audio data. Based on the maximum and minimum amplitudes, the system generates a waveform representative of the audio data. The system stores the generated waveform in association with the uploaded video data for use as the audio thumbnail.

### Architecture Overview

Figure (FIG. 1 is a block diagram of an example system environment 100 for a collaborative media system 130. The system environment 100 shown by FIG. 1 comprises one or more client devices 110 communicating via a network 115 with the collaborative media system 130. Additionally, one or more third-party systems 120 may communicate via the network 115 with the collaborative media system 130. In an embodiment, the collaborative media system 130 is a cloud-hosted application. In alternative configurations, different and/or additional components may be included in the system environment 100.

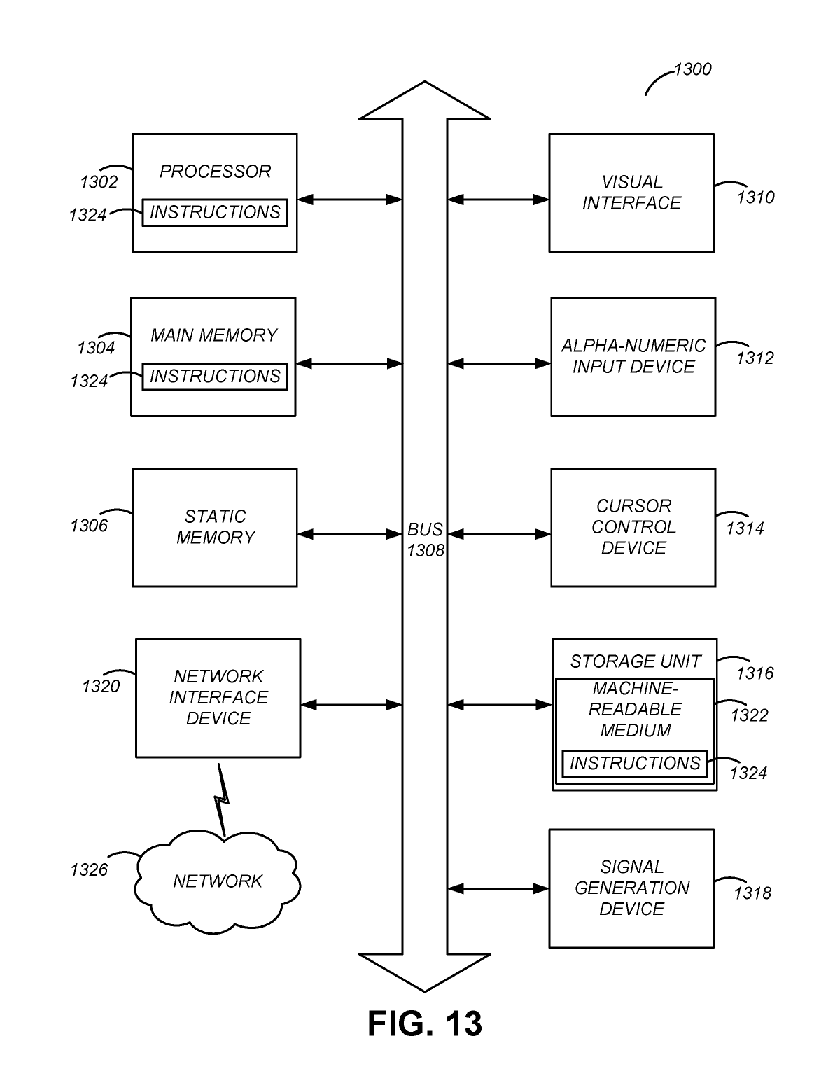

Users interact with the collaborative media system 130 using one or more client devices 110. The client devices 110 are one or more computing devices. The computing devices may be capable of receiving user input as well as transmitting and/or receiving data via the network 115. In one embodiment, a client device 110 is a conventional computer system, such as a desktop or a laptop computer. Alternatively, a client device 110 may be a device having computer functionality, such as a mobile telephone, a smartphone, a tablet, or another suitable device. In an embodiment, an example architecture of a client device 110 is illustrated in conjunction with FIG. 13. In other embodiments, the architecture of the client device 110 may differ.

A client device 110 executes an application allowing a user of the client device 110 to interact with the collaborative media system 130. In one embodiment as shown in FIG. 1, the client device 110 includes a web browser 112. For example, a client device 110 executes a browser application using the web browser 112 to enable interaction between the client device 110 and the collaborative media system via the network 115. In another embodiment, a client device 110 interacts with the collaborative media system 130 through an application programming interface (API) running on a native operating system of the client device 110 (e.g., IOS®, ANDROID™, WINDOWS, LINUX).

As in the embodiment shown in FIG. 1, the client device 110 additionally includes an audio/video player 114 and a desktop recording server 116. The audio/video player 114 includes a sound system and a video system. The sound system may be one or more of: loudspeakers, headphones, microphone, or other audio systems capable of receiving and/or outputting audio data. The video system includes one or more of: cameras, webcams, monitors, other video systems capable of receiving and/or outputting video data.

The desktop recording server 116 interacts with the audio/video player 114 to locally record audio or video data and communicates via the network 115 with the collaborative media system 130 to upload the recorded audio or video data. In one embodiment, the desktop recording server 116 is initiated responsive to a request from the client device 110 to begin a recording session. The desktop recording server 116 initiates a connection with an audio or video server of the collaborative media system 130. In one example, the desktop recording server 116 initiates a connection to the collaborative media system 130 at the start of a recording session to receive audio data for background music playback. The audio data is buffered by the desktop recording server 116 in order to minimize background audio playback glitches during a recording session. While the desktop recording server 116 is active, audio or video data recorded by the audio/video player 114 are locally stored on a hard drive of the client device 110. The desktop recording server 116 synchronizes audio and video captured by the audio/video player 114 of the client device. The desktop recording server 116 compresses the stored audio or video data into multimedia files and transmits them to be uploaded to the collaborative media system 130.

The client devices 110 are configured to communicate via the network 115, which may comprise any combination of local area and/or wide area networks, using both wired and/or wireless communication systems. In one embodiment, the network 115 uses standard communications technologies and/or protocols. For example, the network 115 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 115 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 115 may be represented using any suitable format, such as hypertext markup language (HTML) or extensible markup language (XML). In some embodiments, all or some of the communication links of the network 115 may be encrypted using any suitable technique or techniques.

One or more third-party systems 120 may be coupled to the network 115 for communicating with the collaborative media system 130. A third-party system 120 may be associated with, for example, a business, organization, sponsor, or other content provider. In one embodiment, a third-party system communicates with the collaborative media system 130 to provide audio data, video data, and/or processing tools or methods.

The collaborative media system 130 allows users to access, store, and modify audio and video data in real-time on a remotely hosted platform. Interactions with the collaborative media system 130 via client devices 110 allows users to collaborate on projects with common file formats, processing tools, and shared access to projects without limitations due to data storage space. Because audio and video data are hosted remotely by the collaborative media system 130, audio and video files are transmitted in real-time to client devices 110 upon request for frame-by-frame processing by users. Additionally, the collaborative media system 130 communicates with one or more third-party systems 130 to perform processing actions on audio and video data.

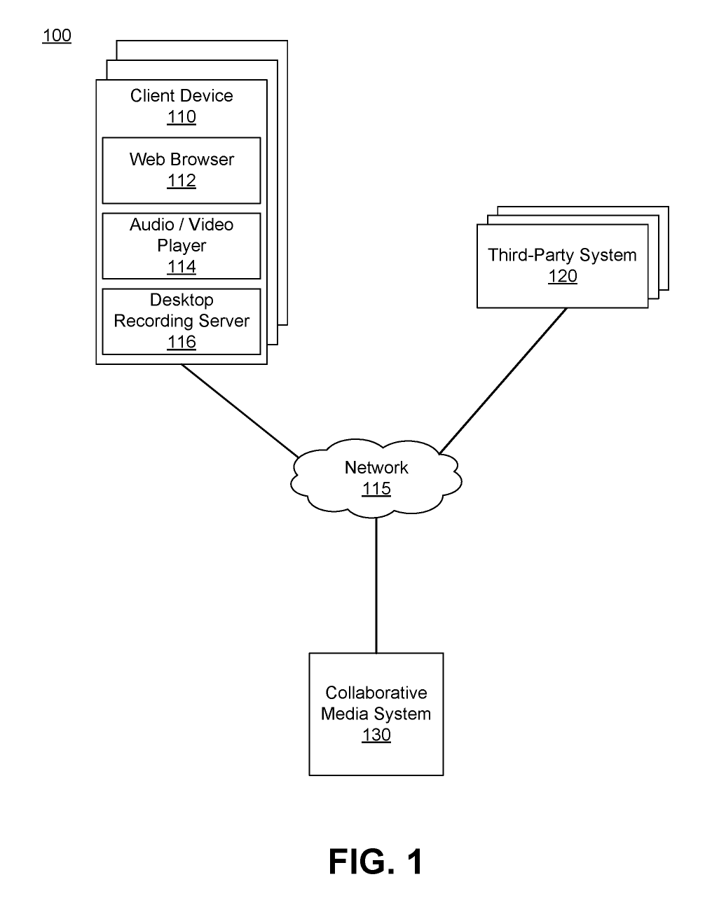

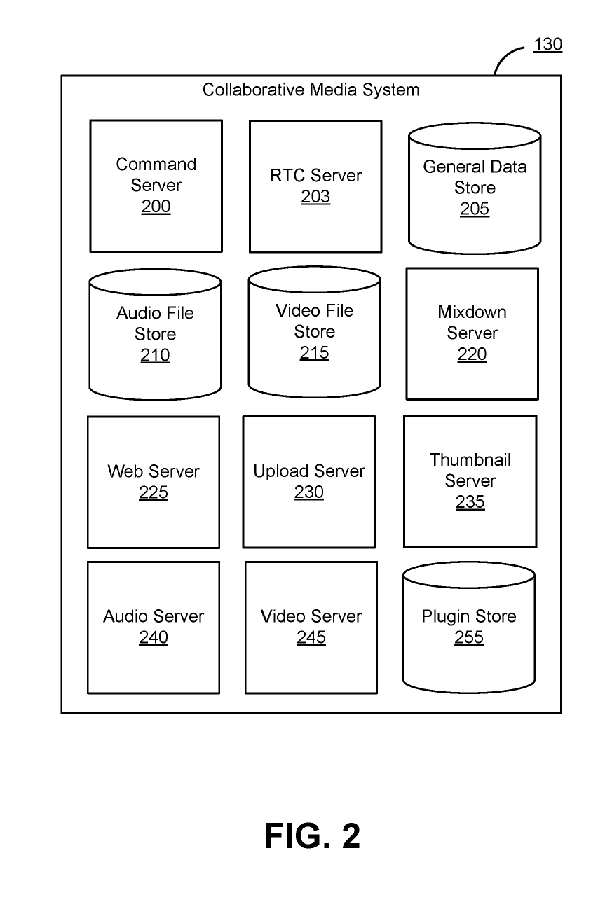

FIG. 2 is a block diagram of an example architecture of the collaborative media system 130. The collaborative media system 130 shown in FIG. 2 includes a command server 200, a Real Time Connection (RTC) server 203, a general data store 205, an audio file store 210, a video file store 215, a mixdown server 220, a web server 225, an upload server 230, a thumbnail server 235, an audio server 240, a video server 245, and a plugin store 255. In other embodiments, the collaborative media system 130 may include additional, fewer, or different components for various applications. In other embodiments, functions described in association with servers in FIG. 2 may be performed by other servers. Additionally, in other embodiments, one or more servers may be combined in a single hardware structure, server, or computer.

The command server 200 may be configured to receive user commands from one or more client devices 110 and distribute the received user commands to servers for execution. The command server 200 is a primary connection to the network 115, such that requests by client devices 110 to the collaborative media system 130 are received by the command server 200. User commands identify actions to be executed on the collaborative media system 130. For example, user commands may be actions to initiate a connection with a server (e.g., begins a ‘session’), to access audio or video data, to access user profiles or messages, to process audio or video data, and the like. Based on the user command, the command server 200 transmits the user command to one or more of the RTC serve 203, the mixdown server 220, the web server 225, the upload server 230, the audio server 240, or the video server 245.

The Real Time Connection (RTC) server 203 may be configured to receive and execute user commands from the command server 200 in real-time. User commands received by the RTC server 203 identify processing actions to be executed in real-time on the collaborative media system. For example, the RTC server 203 receives user commands for playing audio and/or video data, applying plugins to audio or video data, cropping audio or video data, combining audio and/or video data, and the like. Responsive to receiving the user command, the RTC server 203 identifies a command type associated with the command. For example, the RTC server 203 identifies an audio command type for a user command to apply a processing tool to audio data. Based on the command type, the RTC server 203 transmits the user command to a server for execution.

The RTC server 203 additionally may be configured to receive outputs from executed user commands from one or more servers. User commands may generate one or more outputs, which are synchronized by the RTC server 203 and transmitted to the client device 110 associated with the user command.

The audio file store 210 may be configured to store and maintain audio files for the collaborative media system 130. Audio files may be uploaded by users of client devices 110 or third-party systems 120. Audio files may additionally be sourced through other means. In one embodiment, an audio file includes audio data and is associated with an audio thumbnail. The audio thumbnail is a waveform representative of the audio data. In other embodiments, the audio file may additionally include other data and metadata describing the audio data.

The video file store 215 may be configured to store and maintain video files for the collaborative media system 130. Video files may be uploaded by users of client devices 110 or third-party systems 120. Video files may additionally be sourced through other means. In one embodiment, a video file includes video data and is associated with a static video image and a thumbnail video. The static video image is a single frame of the video data and is used to represent the video data. The thumbnail video is one or more frames of the video data and is used to summarize the video data. In other embodiments, the video file may additionally include other data and metadata describing the video data.

The mixdown server 220 may be configured to combine one or more video and audio data into a single multimedia file, allowing users of the collaborative media system 130 to save and publish their work after editing. Responsive to a request by a user to save one or more video and audio data, the mixdown server 220 compresses the video and audio data into a single file. In one embodiment, the file is a video file in a standard format (e.g., MP4). The file is transmitted video file store 215 for storage. In an embodiment, the file may additionally be downloaded to the client device 110 for local storage, playback, or publication on third-party systems or websites.

The web server 225 may be configured to store website content to be presented to users of the collaborative media system 130 when accessed by a client device 110. In one embodiment, the web server 225 receives a request to generate websites via the network 115. The web server 225 provides a website to client devices 110, the website including a user interface allowing users to interact with the collaborative media system 130. For example, the web server 225 generates an editing interface allowing users of the collaborative media system 130 to access, modify, and save video and audio files associated with the collaborative media system. In another example, the web server 225 generates an interface allowing users to interact with other users of the collaborative media system, such as via posts, messaging, or other communication channels, to enable communication and collaboration between users.

The upload server 230 may be configured to receive audio and video data uploaded to the collaborative media system 130 by users and convert the audio and video data to an internal format of the collaborative media system. In an embodiment, audio data is converted to uncompressed 44.1 kilohertz (KHz) WAV files. In an embodiment, video data is converted to 720p h.264 MP4 files. In one embodiment, the upload server 230 converts uploaded audio and video data to an internal format determined based on a status of the uploading user. For example, audio and video data uploaded by a user with a basic status type are converted by the upload server 230 to an MP3 audio files and 360p video files, respectively. Audio and video data uploaded by a user with a higher status type are converted to 49 KHz+ audio files and 1080p or higher video files, respectively.

In one embodiment, the upload server 230 may be configured to generate preview videos for video data uploaded to the collaborative media system 130. Preview videos are lower resolution versions of video data used during real-time edits and other processes. By using lower resolution versions of video data, the collaborative media system 130 experiences less load on processing servers during live editing.

The thumbnail server 235 may be configured to receive uploaded audio and video data and generate thumbnails to represent the uploaded data. Responsive to audio data being uploaded to the collaborative media system 130, the thumbnail server 235 generates an audio thumbnail for the audio data. In one embodiment, the audio thumbnail is a waveform created by sampling the audio data to determine maximum and minimum amplitudes for the sampled audio data. Responsive to video data being uploaded to the collaborative media system 130, the thumbnail server 235 generates a static video image and a thumbnail video for the video data. In one embodiment, the static video image is a frame of the video data and the thumbnail video is one or more frames of the video data. The thumbnails generated by the thumbnail server 235 are stored by the collaborative media system 130 and used to represent or summarize the associated audio or video data.

The audio server 240 may be configured to receive user commands identified as an audio command type from the RTC server 203 and execute actions based on the user commands. Responsive to the RTC server 203 transmitting an audio user command to the audio server 240, the audio server determines a method for executing the user command. For example, a user command is executed locally on the audio server 240. In another example, the audio server 240 identifies a third-party system 120 for executing the user command. In another example, a user command requests access to a plugin or another resource of the collaborative media system 130. Responsive to the user command being executed, the audio server 240 transmits the output of the user command to the RTC server 203.

The video server 245 may be configured to receive user commands identified as a video command type from the RTC server 203 and execute actions based on the user commands. Responsive to the RTC server 203 transmitting a video user command to the video server 245, the video server determines a method for executing the user command. For example, a user command is executed locally on the video server 245. In another example, the video server 245 identifies a third-party system 120 for executing the user command. In another example, a user command requests access to a plugin or another resource of the collaborative media system 130. Responsive to the user command being executed, the video server 245 transmits the output of the user command to the RTC server 203.

The plugin store 255 may be configured to receive and maintain plugins or other effects from client devices 110 or third-party systems 120 for use by users of the collaborative media system 130. Plugins are, for example, binary software libraries or dynamic link libraries (DLL). Because plugins from unknown users or third-party systems 120 may be untrustworthy to users, users access the plugins via a client device 110. The plugin store 255 allows the RTC server 203, audio servers 240, or video servers 245 to access and apply stored plugins without downloading for local use on a client device 110.

### Real Time Connection (RTC) Server

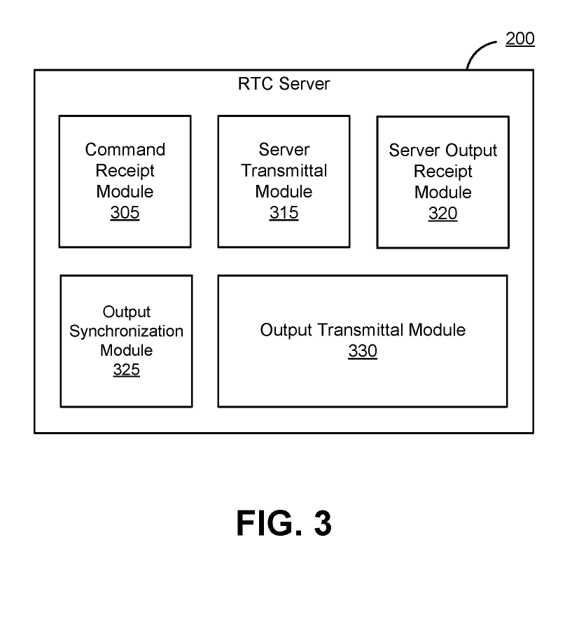

FIG. 3 is a block diagram of an example architecture of the RTC server 203. The RTC server 203 shown in FIG. 3 may include a command receipt module 305, a server transmittal module 315, a server output receipt module 320, an output synchronization module 325, and an output transmittal module 330. In other embodiments, the RTC server 203 may include additional, fewer, or different components for various applications.

The command receipt module 305 is configured to receive user commands from the command server 200. As described in conjunction with FIG. 2, a user command identifies an action to be executed in real-time on the collaborative media system 130. For example, a user command accesses audio or video data, performs a processing action on audio or video data, or stores modified or uploaded audio or video data. A user command is associated with the requesting user of the collaborative media system 130. For example, the user command is associated with a user ID or username. In another example, the user command is associated with an identifier of the client device 110.

The command receipt module 305 may be configured to identify, for each user command, a command type. For example, user commands directed to an action performed on audio data (e.g., accessing, storing, or processing audio data) are identified as audio commands. In another example, user commands directed to an action performed on video data (e.g., accessing, storing, or processing video data) are identified as video commands. In other examples, other command types may be identified. In one embodiment, user commands may be associated with multiple command types (e.g., a request to perform a modification on data including audio and video data). The command receipt module 305 transmits the user command and the associated command type to the server transmittal module 315.

The server transmittal module 315 is configured to identify servers to execute user commands based on associated command types and transmits user commands to the identified servers. In one embodiment, the servers are part of the collaborative media system 130. In another embodiment, the servers are third-party systems 120 communicatively coupled to the collaborative media system 130 to perform user commands in real time. The server transmittal module 315 identifies one or more servers associated with a command type of a received user command and transmits the user command to the server for execution. For example, the server transmittal module 315 identifies an audio command type for a received user command and transmits the user command to the audio server 240. In another example, the server transmittal module 315 identifies a video command type for a received user command and transmits the user command to the video server 245. In other examples, the server transmittal module 315 identifies other command types and transmits the user command to other servers.

The server output receipt module 320 may be configured to receive outputs from servers associated with executed user commands. User commands may generate one or more outputs from one or more servers. An output may be audio data or video data stored by the collaborative media system 130 or modified by an action; an initiation, modification, or end to access for a processing tool or plug-in; or other outputs associated with actions performed by the collaborative media system. In one example, a user command may be used to play audio data so that the output is a next block of audio data including one or more audio samples (e.g., a next 10 milliseconds of audio data). In another example, a user command may be used to play video data so that the output is a next frame or set of frames of video data. In one embodiment, the server output receipt module 320 performs a pull action at specified time intervals or responsive to a user command being transmitted by the server transmittal module 315. The server output receipt module 320 transmits the received outputs to the output synchronization module 325.

The output synchronization module 325 may be configured to receive outputs of executed user commands and synchronizes one or more outputs for display to users of the collaborative media system 130. Synchronization of the one or more outputs compresses large file sizes to be transmitted to client devices 110 in real time. Additionally, synchronization of the one or more outputs ensures that multiple actions requested by users of the collaborative media system 130 are transmitted in a correct time order based on receipt of the user commands. In one embodiment, the output synchronization module 325 is an audio/video multiplexor compressor. In other embodiments, other data compressors or other synchronization methods may be used.

The output transmittal module 330 may be configured to receive synchronized outputs from the output synchronization module 325 and transmits the synchronized outputs to client devices 110 associated with the user command. In one embodiment, the synchronized outputs are associated with an identifier for a client device 110. The output transmittal module 330 performs a push action to transmit the synchronized outputs to the identified client device 110, which can then display the outputs to the user.

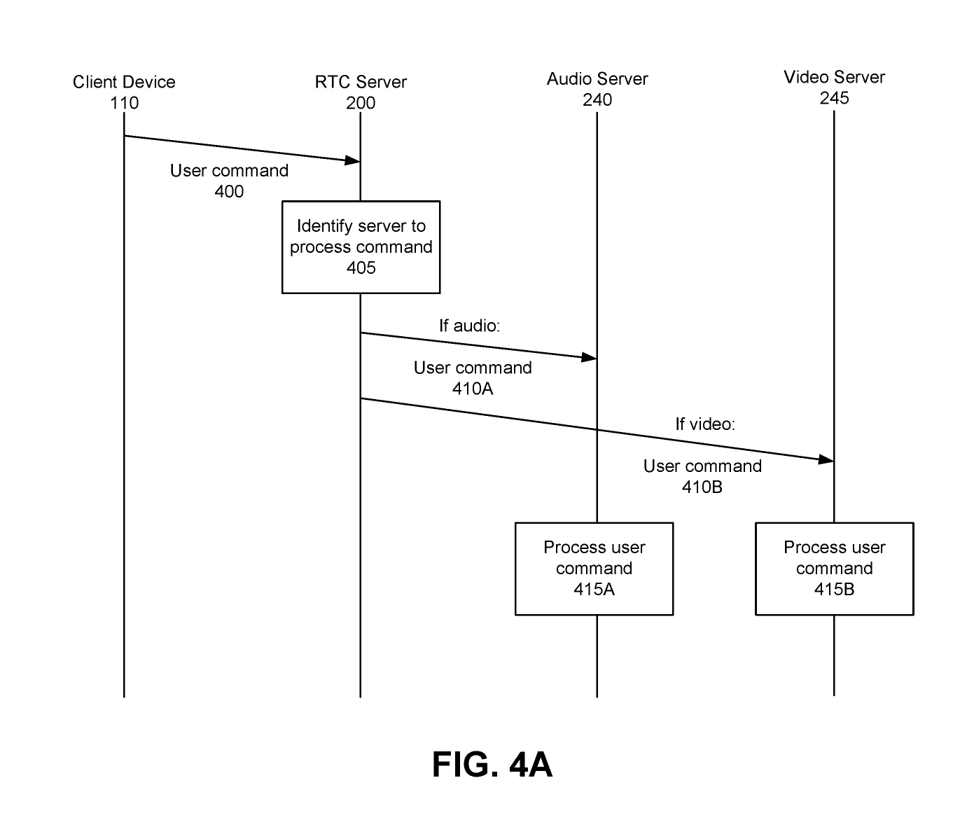

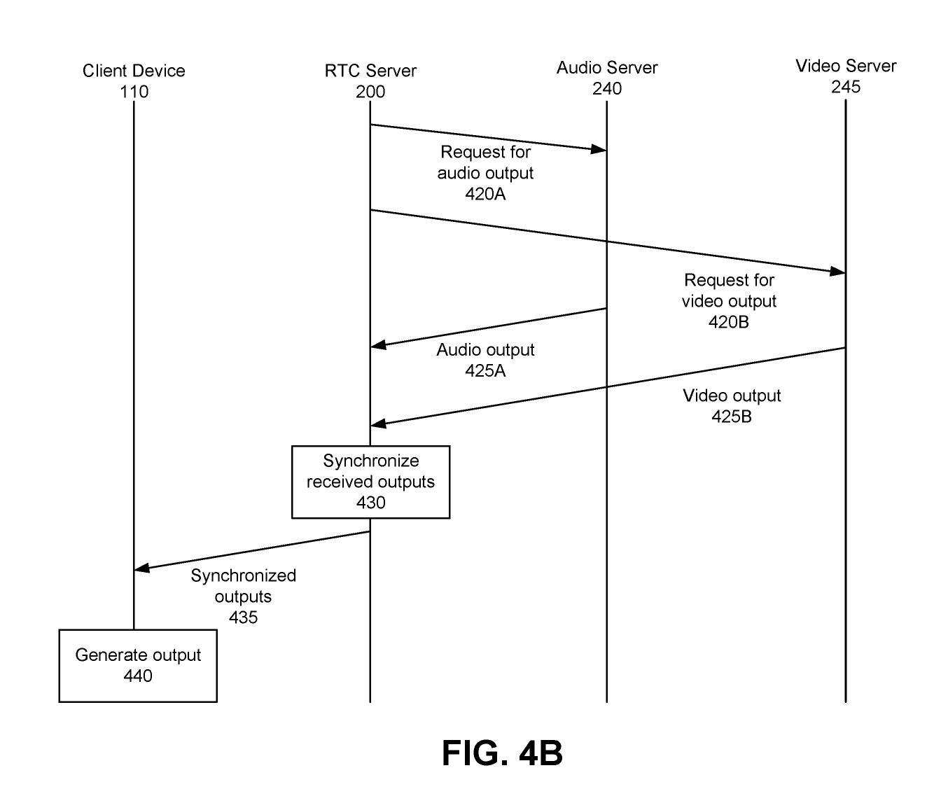

FIGS. 4A-4B are a transaction diagram illustrating example interactions between a client device 110, RTC server 203, audio server 240, and video server 245. A user of the collaborative media system 130 uses a client device 110 to send a user command 400 to the RTC server 203. The RTC server 203 identifies 405 a server to process the user command. In one embodiment, the RTC server 203 identifies a server based on a command type associated with the user command. If the user command is identified as an audio command, the RTC server 203 transmits the user command 410A to the audio server 240. The audio server 240 processes 415A the user command. If the user command is identified as a video command, the RTC server 203 transmits the user command 410B to the video server 245. The video server 245 processes 415B the user command.

The RTC server 203 may be configured to transmit a request 420A to the audio server 240 for audio output associated with an executed audio command. The RTC server 203 additionally transmits a request 420B to the video server 245 for video output associated with an executed video command. In one embodiment, the pull requests 420 are transmitted at regular intervals. In other embodiments, the pull requests 420 are transmitted responsive to a user command being sent to a server. The audio server 240 transmits audio outputs 425A to the RTC server 203. The video server 245 additionally transmits video outputs 425B to the RTC server 203. For a pull request 420, there may be no outputs, no video outputs, no audio outputs, one or more video outputs, one or more audio outputs, or both audio and video outputs.

The RTC server 203 may be configured to synchronize 430 the received outputs. In one embodiment as discussed in conjunction with FIG. 3, the synchronization is performed using an audio/video multiplexor compressor. The RTC server 203 may be configured to transmit the synchronized outputs 435 to the client device 110 associated with the user command. The client device 110 generates 440 an output for display to the user of the collaborative media system 130. For example, the client device 110 plays requested audio or video data, modifies audio or video data, modifies a user interface associated with the collaborative media system 130, modifies settings for the connection between the client device and the collaborative media system, or the like.

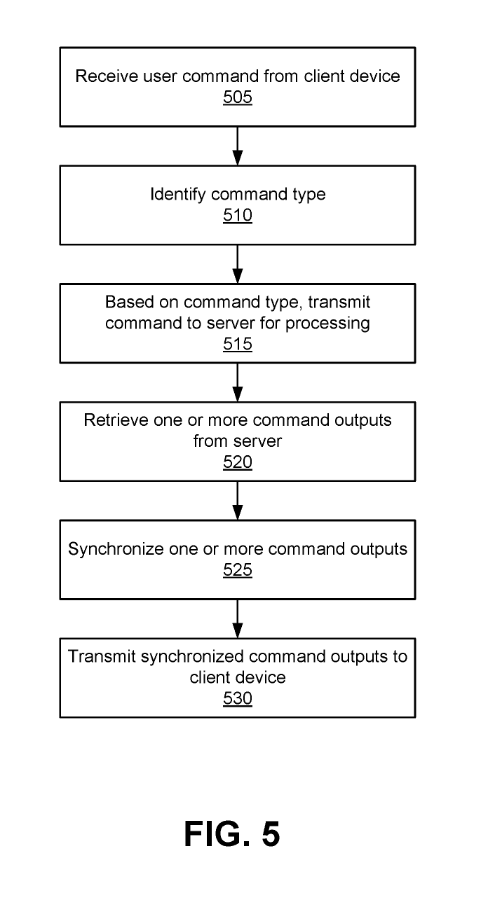

FIG. 5 is a flowchart illustrating an example process for remote processing audio and video user commands according to one embodiment. In some embodiments, the process may be performed by the RTC server 203, although some or all of the operations in the method may be performed by other entities in other embodiments. In some embodiments, the operations in the flow chart may be performed in a different order and can include different and/or additional steps.

The RTC server 203 receives 505 a user command from a client device 110. The user command identifies an action to be executed in real-time by the collaborative media system 130. Based on the action, the RTC server 203 identifies 510 a command type of the user command. For example, a user command may be an audio command or a video command. The RTC server 203 transmits 515 the user command to a server to be processed and executed, the server selected based on the command type. For example, for an audio command, the RTC server 203 transmits the user command to an audio server 240. In another example, for a video command, the RTC server 203 transmits the user command to a video server 245.

The RTC server 203 retrieves 520 one or more command outputs from the server and synchronizes 525 the one or more command outputs. In one embodiment, the RTC server 203 uses an audio/video multiplexor compressor to synchronize the one or more command outputs. The RTC server 203 transmits 530 the synchronized command outputs to the client device 110 for display.

### Thumbnail Server

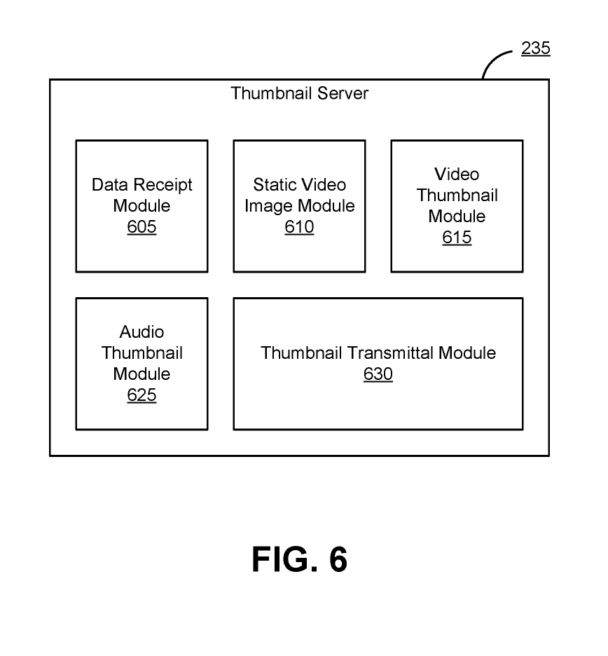

FIG. 6 is a block diagram of an example architecture of the thumbnail server 235. The thumbnail server 235 shown in FIG. 6 may include a data receipt module 605, a static video image module 610, a video thumbnail module 615, an audio thumbnail module 625, and a thumbnail transmittal module 630. In other embodiments, the thumbnail server 235 may include additional, fewer, or different components for various applications.

The data receipt module 605 may be configured to receive video and audio data uploaded to the collaborative media system 130 and transmit the uploaded data for thumbnail generation. Video and audio data may be uploaded to the collaborative media system 130 by client devices 110, third-party systems 120, or other methods via the network 115. The data receipt module 605 identifies whether the uploaded data is audio data or video data. Responsive to identifying that uploaded data is video data, the data receipt module 605 transmits the uploaded video data to the static video image module 610 and the video thumbnail module 615. Responsive to identifying that uploaded data is audio data, the data receipt module 605 transmits the uploaded audio data to the audio thumbnail module 625.

The static video image module 610 may be configured to receive uploaded video data from the data receipt module 605 and generate a static video image for the video data. The static video image is a frame from the uploaded video data used by the collaborative media system 130 to represent the uploaded video data. The static video image module 610 selects a set of frames from the video data. In one embodiment, the selection is performed at a series of non-contiguous time intervals based on the length of the video data. For example, the static video image module 610 selects a set of 10 frames from 10 minutes of video data, the set of 10 frames associated with timestamps at 0:00, 1:00, 2:00 . . . 9:00, 10:00. In another example, the static video image module 610 selects a set of 5 frames from 1 minute of video data, the set of 5 frames associated with timestamps at 0:00, 0:12, 0:24 . . . 0:48, 1:00. In other embodiments, the static video image module 610 selects a different number of frames or selects frames at different time intervals.

The static video image module 610 may be configured to select a subset of the set of frames based on a threshold amount of time from the start and end of the video data. For example, the static video image module 610 determines predefined programmable amount, e.g., 20% of the length of the video data, and selects the subset of frames based on the associated timestamps of the frames being after 20% of the start of the video data and before 20% of the end of the video data. In other embodiments, other threshold times are used to select the subset of frames. The static video image module 610 determines a bit size for each of the selected frames. The bit size represents an interestingness of the frame. The static video image module 610 selects a frame from the subset of frames based on the determined bit sizes. In one example, the static video image module 610 selects a frame based on a highest bit size. The selected frame is transmitted to the thumbnail transmittal module 630 for use as the static video image for the uploaded video data.

The video thumbnail module 615 may be configured to receive uploaded video data from the data receipt module 605 and generate a video thumbnail for the video data. The video thumbnail is a set of frames from the video data used by the collaborative media system 130 to represent a summary of the uploaded video data. The video thumbnail module 615 selects a set of frames from the video data. In one embodiment, the selection is performed at a series of time intervals. For example, the selection is performed at 1 second intervals, such that the set of frames is associated with timestamps at 0:00:00, 0:01:00, 0:02:00 . . . . In other examples, the selection is performed at different time intervals. The video thumbnail module 615 combines the selected set of frames to create the thumbnail video. The thumbnail video is transmitted to the thumbnail transmittal module 630.

The audio thumbnail module 625 may be configured to receive uploaded audio data from the data receipt module 605 and generate an audio thumbnail for the audio data. The audio thumbnail is a waveform representation of the uploaded audio thumbnail. The audio thumbnail module 625 identifies blocks of audio data, each block corresponding to a time interval. For example, the audio thumbnail module 625 identifies blocks at a frequency of 25 Hertz (Hz), such that each block corresponds to 40 milliseconds (ms) of audio data. For each block of audio data, the audio thumbnail module 625 measures a maximum amplitude and a minimum amplitude and stores the maximum and minimum amplitudes for each block of audio data. Based on the maximum and minimum amplitudes for the audio data, the audio thumbnail module 625 generates a waveform representative of the determined maximum and minimum amplitudes.

In one embodiment, uploaded audio data may be associated with a left channel and a right channel. The audio thumbnail module 625 determines a set of maximum amplitudes and a set of minimum amplitudes for each channel of the uploaded audio data.

In an embodiment, the maximum and minimum amplitudes are stored as 16 bits, such that the lower 8 bits correspond to the minimum amplitude and the upper 8 bits correspond to the maximum amplitude. The values are stored in a specified file format, e.g., .wav file. In a case where audio data includes a left channel and a right channel, the values for the left channel are stored separately from the values for the right channel. In other embodiments, other formatting or file types may be used.

The thumbnail transmittal module 630 may be configured to receive audio and video thumbnails generated by the static video image module 610, the video thumbnail module 615, and the audio thumbnail module 625 and transmit the audio and video thumbnails to be stored in association with the uploaded audio and video data. For example, the thumbnail transmittal module 630 receives uploaded video data, a corresponding static video image, and a corresponding video thumbnail. The thumbnail transmittal module 630 transmits the received video data, static video image, and video thumbnail to the video file store 215 for storage. In another example, the thumbnail transmittal module 630 receives uploaded audio data and a corresponding audio thumbnail. The thumbnail transmittal module 630 transmits the received audio data and audio thumbnail to the audio file store 210 for storage.

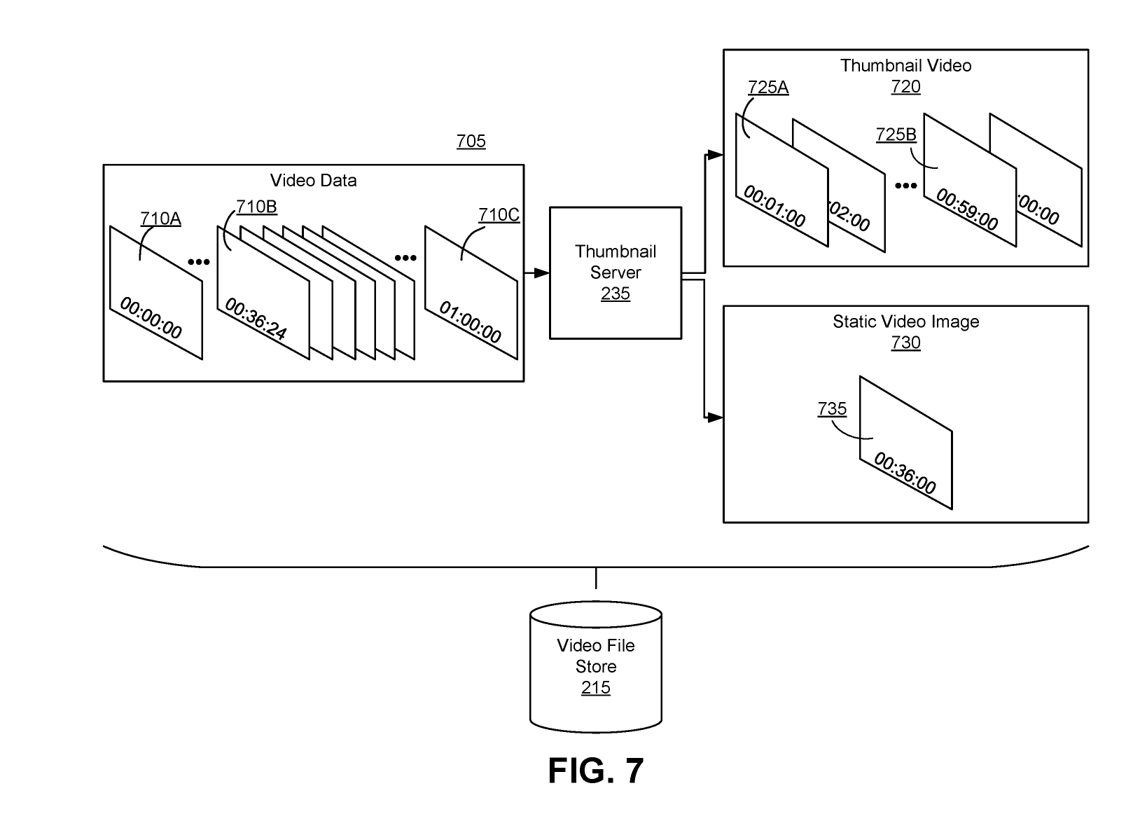

FIG. 7 is an illustration of an example process for generating thumbnails for video data, according to an embodiment. Video data 705 is uploaded to the collaborative media system 130. The video data 705 includes one or more frames 710, each frame associated with a timestamp (“00:00:00,” “00:36:24,” “01:00:00,” etc.). Responsive to being uploaded to the collaborative media system 130, the video data 705 is transmitted to the thumbnail server 235. As discussed in conjunction with FIG. 6, the thumbnail server 235 generates a thumbnail video 720 and a static video image 730 from the uploaded video data 705.

The thumbnail video 720 may include a set of frames 725 sampled from the frames 710 of the video data. For example, as shown in the example of FIG. 7, the set of frames 725 is selected at 1 second intervals, such that the frames are associated with timestamps at 00:01:00, 00:02:00 . . . 00:59:00, 01:00:00. The static video image 730 is selected based from a subset of frames from the video data 705. For example, the thumbnail server 235 identifies 10 frames from the video data 705 and determines a bit size associated with each of the selected frames. Based on the determined bit sizes, the thumbnail server 235 identifies a frame 735 for use as the static video image 730.

The thumbnail server 235 may be configured to transmit the video data 705, the thumbnail video 720, and the static video image 730 to the video file store 215 for storage. At a later time, when the video data 705 is requested by a client device 110, the associated thumbnail video 720 and static video image 730 are provided in association with the video data, such that the thumbnail video 720 and static video 730 image may be viewed by a user of the collaborative media system 130.

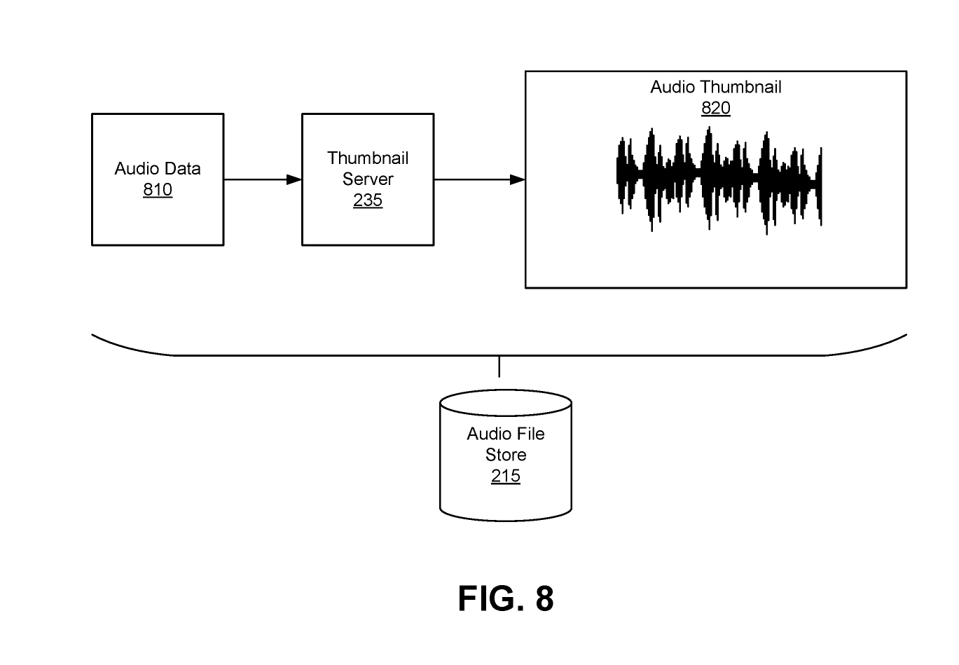

FIG. 8 is an illustration of an example process for generating thumbnails for audio data, according to an embodiment. Audio data 810 is uploaded to the collaborative media system 130. In one embodiment, the audio data 810 may include a left channel and a right channel. Responsive to being uploaded to the collaborative media system 130, the audio data 810 is transmitted to the thumbnail server 235. As discussed in conjunction with FIG. 6, the thumbnail server 235 generates an audio thumbnail 820 from the uploaded audio data 810.

The audio thumbnail 820 includes a waveform based on averaged samples of the audio data 810. For example, the thumbnail server 235 samples the uploaded audio data 810 at a frequency of 25 Hz and determines, for each sample, a maximum frequency value and a minimum frequency value. The maximum and minimum frequency values are used to generate a waveform summarizing the uploaded audio data 810. For example, the thumbnail server 235 determines separate waveforms for the left channel and the right channel. Each waveform represents the maximum and minimum frequency values for the corresponding audio data.

The thumbnail server 235 transmits the audio data 810 and the audio thumbnail 820 to the audio file store 210 for storage. At a later time, when the audio data 810 is requested by a client device 110, the associated audio thumbnail 820 is provided in association with the audio data, such that the audio thumbnail may be viewed by a user of the collaborative media system 130.

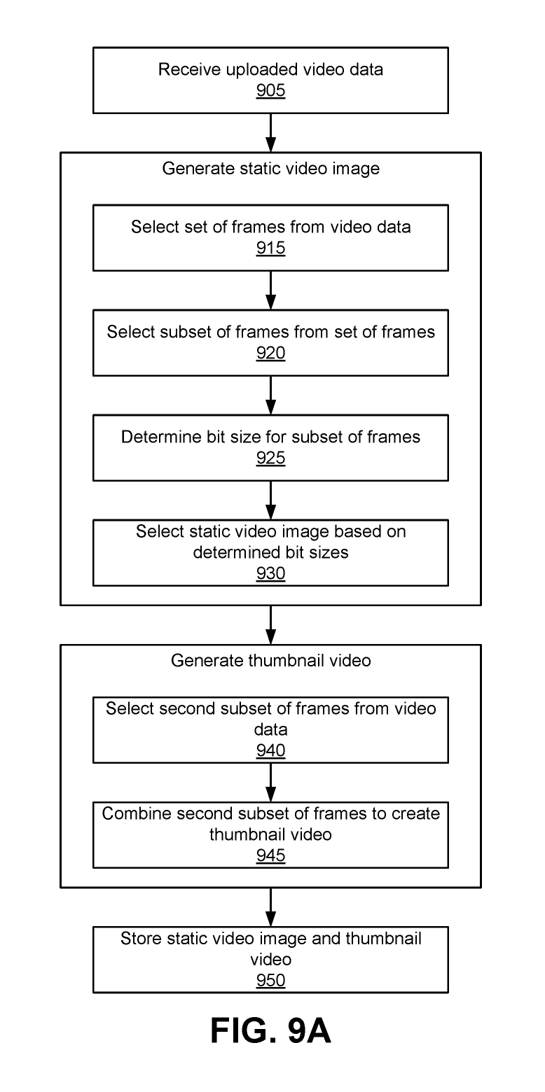

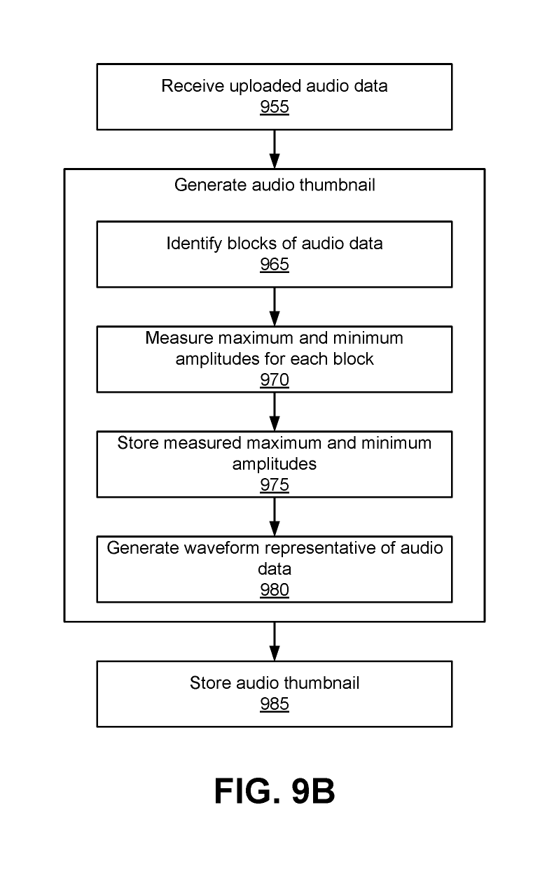

FIG. 9A is a flowchart illustrating an example process for generating thumbnails for video data, according to an embodiment. In some embodiments, the process is performed by the thumbnail server 235, although some or all of the operations in the process may be performed by other entities in other embodiments. In some embodiments, the operations in the flow chart may be performed in a different order and can include different and/or additional steps.

The thumbnail server 235 receives video data uploaded to the collaborative media system 130. The video data includes one or more frames, each frame associated with a timestamp. The thumbnail server 235 generates a static video image. The static video image is a single frame of the video data used to represent the video data. The thumbnail server 235 selects 915 a set of frames from the video data. For example, the thumbnail server 235 selects 10 frames at equally spaced time intervals from the video data. The thumbnail server 235 selects 920 a subset of frames from the set of frames. For example, the thumbnail server 235 selects frames with timestamps between the first 20% of the video data and the last 20% of the video data. The selected frames may be non-contiguous. The thumbnail server 235 determines 925 a bit size for each frame of the subset of frames. Based on the determined bit sizes, the thumbnail server 235 selects 930 a static video image.

The thumbnail server 235 generates a thumbnail video for the uploaded video data. The thumbnail video is one or more frames of video data used to summarize the video data. The thumbnail server 235 selects 940 a second subset of frames from the video data. In one embodiment, the second subset of frames are selected at 1 second time intervals for the duration of the video data. The thumbnail server 235 combines 945 the second subset of frames to create the thumbnail video.

The thumbnail server 235 stores 940 the static video image and thumbnail video in association with the uploaded video data for use by the collaborative media system 130.

FIG. 9B is a flowchart illustrating an example process for generating thumbnails for audio data, according to an embodiment. In some embodiments, the process is performed by the thumbnail server 235, although some or all of the operations in the process may be performed by other entities in other embodiments. In some embodiments, the operations in the flow chart may be performed in a different order and can include different and/or additional steps.

The thumbnail server 235 receives 955 audio data uploaded to the collaborative media system 130. The audio data may include two or more channels, e.g., a left channel and a right channel. The thumbnail server 235 generates an audio thumbnail for the uploaded audio data. The audio thumbnail may be a waveform used by the collaborative media system 130 to visually summarize the audio data. The thumbnail server 235 identifies 965 blocks of audio data. For example, the thumbnail server 135 samples the audio data at a frequency of 25 Hz to generate the blocks of audio data. The thumbnail server 235 measures 970 a maximum and minimum frequency value for each of the identified audio samples and stores 975 the measured maximum and minimum frequency values. Based on the maximum and minimum frequency values, the thumbnail server 235 generates 980 a waveform representative of the audio data. For example, the thumbnail server 235 generates a 16 bit file, e.g., a .wav file, wherein the upper 8 bits represent the maximum frequency value and the lower 8 bits represent the minimum frequency value.

The thumbnail server 235 stores 985 the audio thumbnail in association with the uploaded audio data for use by the collaborative media system 130.

### Multi-Machine Architecture

In an embodiment, the audio server 240 includes an audio processing engine that reads, processes, and mixes one or more digital audio streams into a single stream. The audio processing engine includes distributable, modular processing nodes in order to ensure that one or more processes may be performed in parallel to reduce load for a given system or computer and to increase the speed at which multiple operations are performed. This enables the collaborative media system 130 to remotely (e.g., network-centric or cloud) host and execute user requests for frame-by-frame media processing in real-time.

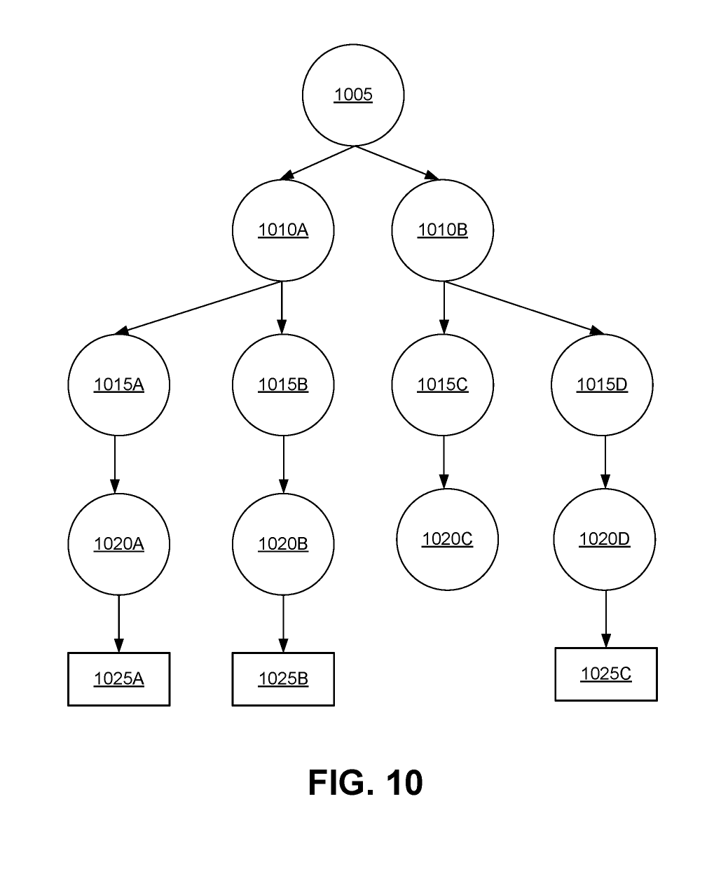

FIG. 10 is an illustration of an example tree structure of an audio processing engine, according to an embodiment. A top-level root node 1005 performs a pull action at periodic time intervals. For example, the top-level root node 1005 performs a pull action once every 100 milliseconds (ms). A pull action by the root node 1005 calls a corresponding pull action for each of the one or more nodes 1010, 1015, 1020 below it until an audio file 1025 is accessed or until an end node 1020C is reached. Each node 1010, 1015, 1020 performs an action on the collaborative media system 130. For example, a node may perform basic audio functions such as a volume adjustment or pan, perform simple functions such as mute or level measurements, or perform higher level audio processing such as dynamic range compression, parametric equalization, or others.

In conventional audio and video media processing systems, nodes that have more than one child node, such as the root node 1005, perform each pull action sequentially. For example, the root node 1005 performs a pull action for a first child node 1010A. The node 1010A performs a pull action for a first child node 1015A and waits for the first child node to execute (e.g., performing a pull action to its child node 1020A, executing an action 1025A) and return an output. Responsive to receiving an output for the first child node 1015A, the node 1010A performs a pull action for a second child node 1015B and waits for the second child node to execute (e.g., performing a pull action to its child node 1020B, executing an action 1025B) and return an output. When the child nodes 1015A-B for the node 1010A have executed their respective actions, the node 1010A performs an action and returns an output to its parent node 1005. Responsive to receiving an output from the node 1010A, the root node 1005 performs a pull action for a second child node 1010B to traverse the remaining portions of the tree.

The collaborative media system 130 implements distributable, modular processing nodes. By hosting nodes for the audio processing engine on one or more computers, systems, or operating systems, the collaborative media system 130 allows nodes to perform pull actions for one or more child nodes simultaneously. Additionally, because one or more nodes may execute actions for particular systems or operating systems (e.g., plug-ins), distributed processing nodes allows the collaborative media system 130 to implement multiple plug-ins requiring different systems. Because video and audio data and processing tools are associated with different formats, operating systems, hardware, and the like, the collaborative media system 130 uses distributable processing nodes to support the ability to run audio and/or video processing on the required operating systems and hardware. The distributed processing nodes further allow processing to occur in different threads of the same machine to speed up total processing time. For example, multiple child nodes may be executed in parallel in different threads.

In an embodiment, the video server 245 includes a video processing engine that reads, processes, and mixes one or more digital video streams into a single stream. As described in conjunction with the audio processing engine, the video processing engine includes distributable, modular processing nodes that may be executable in one or more computing systems. In other embodiments, other servers may include processing engines using distributable, modular processing nodes to execute tasks in one or more computing systems.

### Grid Placement Interface

The collaborative media system 130 provides users with an interface for accessing, modifying, and performing other processing steps on audio and video data. In one embodiment, the collaborative media system 130 provides a grid placement interface for overlaying one or more video and audio files based on a generated grid layout. The use of the grid placement interface allows users of the collaborative media system 130 to easily align, crop, and otherwise adjust the timing of one or more audio and video data. The grid placement interface displays one or more gridlines associated with time placements and durations to a user of the collaborative media system 130.

Responsive to a user dragging selected audio or video data to a section of the grid placement interface, the collaborative media system 130 performs one or more actions to align the time placement and duration of the audio or video data to the corresponding time placement duration indicated by the gridlines. For example, when the length of the audio or video data exceeds the time duration indicated by the gridlines, the collaborative media system 130 crops the audio or video data to correspond to the time duration of the gridlines.

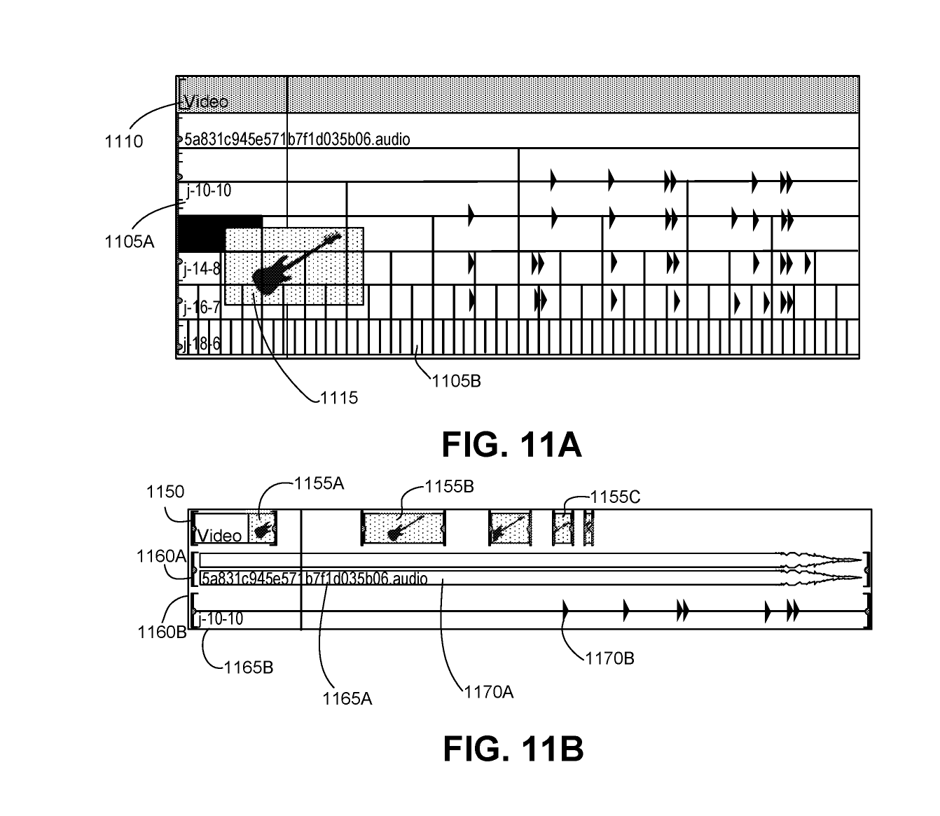

FIGS. 11A-11B are illustrations of example user interfaces for enabling users to place video and audio data in a grid layout, according to an embodiment. FIG. 11A illustrates an example user interface for a grid layout provided by the grid placement interface. A series of gridlines 1105 are displayed to indicate time durations and placements. For example, a first grid area 1105A indicates a first time duration corresponding to a placement at the start of the audio or video data, while a second grid area 1105B indicates a second, shorter time duration corresponding to a placement partway through the audio and video data. In one embodiment, the grid placement interface indicates a data type for placement using a label 1110 (“video,” “audio,” etc.). In other embodiments, one or more data types may be placed on the grid placement interface.

In the example shown in FIG. 11A, a user of the collaborative media system 130 selects video data 1115 for placement on the grid placement interface. The user selects a grid area 1105 by, for example, dragging the video data 1115 to the grid area. Responsive to the grid area 1105 being selected by, for example, the video data 1115 being released over a highlighted grid area, the collaborative media system 130 applies one or more processing tools to the video data. For example, the video data is cropped or adjusted to the time duration associated with the selected grid area 1105. In other examples, other methods of selecting a grid area or processing selected video or audio data may be used.

FIG. 11B illustrates an example user interface for a grid placement interface including multiple audio and video data. The grid placement interface includes video data 1150, the video data including one or more segments 1155, and one or more audio data 1160. The video data segments 1155 are represented using static video images cropped and placed to represent a time duration and placement for the video data segments. For example, a first video segment 1155A is cropped to represent a first duration of time and placed at the start of the audio and video data. A second video segment 1155A is cropped to represent a second, longer duration of time and placed at a later point of the audio and video data.

The grid placement interface additionally shows one or more audio data 1160 placed by a user of the collaborative media system 130. In the example of FIG. 11B, a first audio data 1160A is shown with an identifier 1165A and an audio thumbnail 1170A representing a waveform for the audio data. Areas in the audio thumbnail 1170A indicating a change in volume align with the corresponding times in the video data 1150 and other audio data. For example, a second audio data 1160B is shown with an identifier 1165B and an audio thumbnail 1170B including several points during the video and audio data wherein the second audio data increases in volume, including a first point corresponding to the fourth video segment 1155C. In each instance, the audio and video are aligned at the appropriate time.

In an embodiment, the grid placement interface may be configured to allow users of the collaborative media system 130 to manually place and crop audio and/or video segments. For example, users may select and drag segments of audio and/or video data for placement and indicate a desired duration for the selected segments of audio and/or video data, the placement and desired duration not corresponding to the grid structure outlined by the grid placement interface.

### Song Structure

The collaborative media system 130 allows users to identify a song structure for audio data. By identifying a song structure for audio data, the collaborative media system 130 enables users to more easily combine audio and video data. For example, users may find it desirable to quickly differentiate between a verse and a chorus of a song in order to correctly align video data.

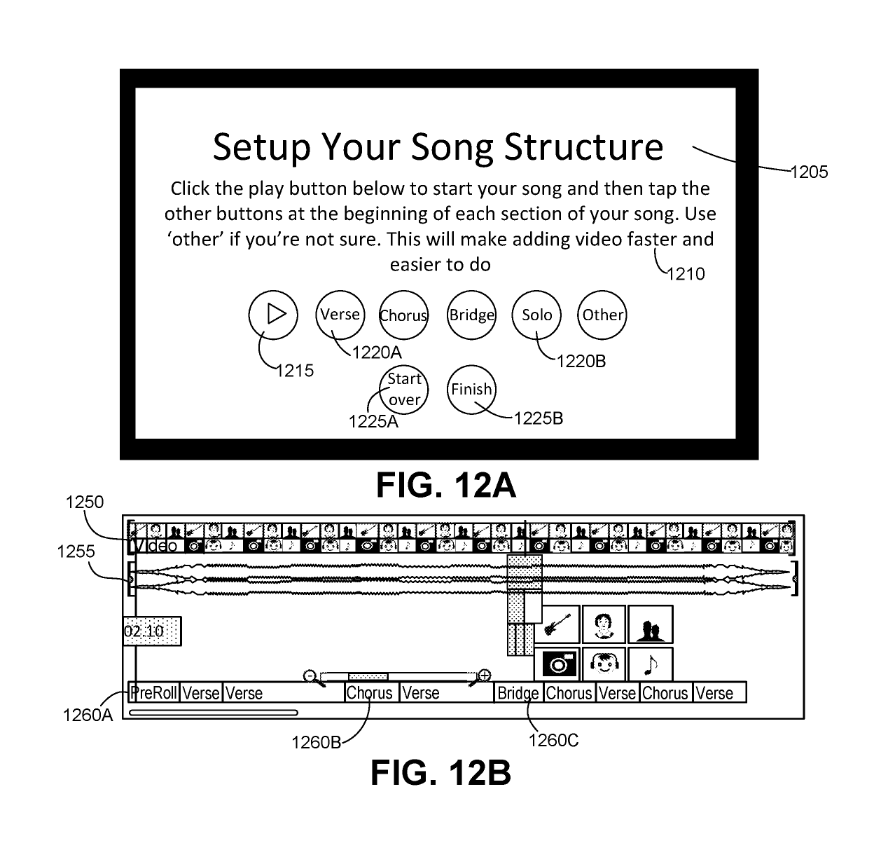

FIGS. 12A-12B are illustrations of example user interfaces for enabling users to identify a song structure for audio data and to apply the identified song structure during processing, according to an embodiment.

FIG. 12A illustrates an example user interface for manually identifying song structures in audio data. Responsive to a request from a client device 110 to initiate the song structure interface, the collaborative media system 130 provides an interface allowing a user to manually indicate a song structure for selected audio data. In the example of FIG. 12A, the song structure interface includes a title 1205 (“Setup Your Song Structure”) and instructions 1210 (“Click the play button below to start your song . . . ”). The song structure interface additionally has a series of buttons that users can interact with via client devices 110. In the example of FIG. 12A, a first button 1215 allows a user to begin playing selected audio data. A second series of buttons 1120 allows a user to indicate, for each portion of audio data being played, a song structure corresponding to the portion of audio data. For example, the buttons 1220 are labeled to indicate that a portion of audio data belongs to song structures “verse,” “chorus,” “bridge,” “solo,” or “other.” In other examples, other song structures may be identified. The song structure interface additionally includes buttons 1225 to restart (“start over”) or to complete (“finish”) the process of song structure identification.

Responsive to a user selecting a button 1215 to play the audio data, the collaborative media system 130 begins playback of the selected audio data. During playback of the selected audio data, users interact with buttons 1220 to indicate a corresponding song structure for a currently played portion of the audio data. Each interaction with the buttons 1220 is stored by the collaborative media system 130 in association with the portion of the audio data. In one embodiment, users may additionally interact with buttons 1225 to restart or to complete the process at any time during or after playback of the audio data. Responsive to an interaction to restart the process 1225A, the collaborative media system 130 discards previously stored interactions by the user for the audio data and initiates playback of the audio data. Responsive to an interaction to complete the process 1225B, the collaborative media system 130 finalizes and stores interactions by the user for the audio data.

In another embodiment, the collaborative media system 130 includes a machine learning model for identifying song structure of audio data. The machine learning model extracts features from selected audio data and, based on the identified features, determines song structures corresponding to portions of the audio data. For example, portions of audio data are identified as a chorus based on repetition of the phrases, repetition of notes, and timing of the portions of audio data. In another example, portions of audio data are identified as a verse due to repetition of notes and differentiation of phrases. The machine learning model stores the identified song structures in association with the corresponding portions of audio data such that users of the collaborative media system 130 can access and use the identified song structures during processing.

The collaborative media system 130 may be configured to train machine learning models using training data. In one embodiment, training data includes audio data with manually identified song structures. For example, the collaborative media system 130 accesses audio data with manually identified song structures from the video file store 210 to form training sets for machine learning models. In one embodiment, the collaborative media system 130 uses supervised machine learning to build the machine learning models using the training sets as inputs. Different machine learning techniques—such as neural networks, linear support vector machine (linear SVM), boosting for other algorithms (e.g., AdaBoost), logistic regression, naïve Bayes, memory-based learning, random forests, bagged trees, decision trees, boosted trees, or boosted stumps—may be used in different embodiments.

In one embodiment, the collaborative media system 130 applies a machine learning model to audio data responsive to the audio data being uploaded to the collaborative media system. In another embodiment, the collaborative media system 130 applies the machine learning model to audio data responsive to a request from a client device 110 to access the audio data and the corresponding song structure.

FIG. 12B illustrates an example user interface for applying an identified song structure for processing. The collaborative media system 130 provides a user interface for processing one or more audio or video data. In the example of FIG. 12B, video data 1250 and audio data 1255 including a left channel and a right channel are displayed by the user interface. The collaborative media system 130 accesses and provides song structures 1260 corresponding to portions of the audio data 1255. For example, the collaborative media system 130 identifies a first portion of the song as corresponding to a “PreRoll” song structure 1260A. Later portions of the song correspond to, for example, a “Chorus” song structure 1260B and a “Bridge” song structure 1260C. Song structures 1260 are displayed to align with the corresponding portion of audio data. In other embodiments, song structures may be displayed differently.

### Computing Machine Architecture

FIG. 13 is a block diagram illustrating components of an example machine able to read instructions from a machine-readable medium and execute them in a processor (or controller). Specifically, FIG. 13 shows a diagrammatic representation of a machine in the example form of a computer system 1300 within which program code (e.g., software) for causing the machine to perform any one or more of the methodologies discussed herein may be executed. The program code may be comprised of instructions 1324 executable by one or more processors 1302. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 1324 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 1300 includes a processor 1302 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 1304, and a static memory 1306, which are configured to communicate with each other via a bus 1308. The computer system 1300 may further include visual display interface 1310. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 1310 may include or may interface with a touch enabled screen. The computer system 1300 may also include alphanumeric input device 1312 (e.g., a keyboard or touch screen keyboard), a cursor control device 1314 (e.g., a mouse, a trackball, a joystick, a motion sensor, or other pointing instrument), a storage unit 1316, a signal generation device 1318 (e.g., a speaker), and a network interface device 1320, which also are configured to communicate via the bus 1308.

The storage unit 1316 includes a machine-readable medium 1322 on which is stored instructions 1324 (e.g., software) embodying any one or more of the methodologies or functions described herein. The instructions 1324 (e.g., software) may also reside, completely or at least partially, within the main memory 1304 or within the processor 1302 (e.g., within a processor's cache memory) during execution thereof by the computer system 1300, the main memory 1304 and the processor 1302 also constituting machine-readable media. The instructions 1324 (e.g., software) may be transmitted or received over a network 1326 via the network interface device 1320.

While machine-readable medium 1322 is shown in an example embodiment to be a single medium, the term “machine-readable medium” should be taken to include a single medium or multiple media (e.g., a centralized or distributed database, or associated caches and servers) able to store instructions (e.g., instructions 1324). The term “machine-readable medium” shall also be taken to include any medium that is capable of storing instructions (e.g., instructions 1324) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

The disclosed configurations beneficially provide a collaborative platform for video and/or audio media processing. Users of the collaborative media platform access the collaborative media platform remotely via client devices, e.g., via a network-centric (or cloud computing) configuration. Because the collaborative media platform may store and host all audio data, video data, and processing tools, users of the collaborative media platform are able access, share, and collaborate on files, plug-ins, and other processing tools in a centralized computing location without difficulties presented by conventional desktop (or local) media processing platforms. For example, users are able to exchange files for collaborative projects without converting between file types or formats or accessing a file via different applications, operating systems, or plugins and processing tools. Additionally, large projects are not limited by file sizes that may cause storage issues on client devices.

The disclosed configurations additionally provide user interfaces for video and/or audio media processing. In an embodiment, the user interfaces include a grid placement interface and/or a song structure interface. The provided user interfaces enable users of the collaborative media platform to quickly identify portions of audio and/or video data for processing.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for providing a collaborative platform for audio and video media processing through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for enabling remote processing for user commands in real-time, the method comprising:
receiving a user command from a client device, the user command identifying an action to be performed;
determining a command type of the user command, the command type describing a type of media associated with the action;
identifying a server to perform the action, the identified server being at least one of an audio server responsive to the command type being an audio command and a video server responsive to the command type being a video command;
transmitting the user command to the identified server for processing;
retrieving, from the identified server, one or more outputs associated with the user command;
synchronizing the one or more outputs; and
transmitting the synchronized outputs to the client device.

2. The method of claim 1, further comprising:
retrieving, from a second server, one or more additional outputs associated with a second user command; and
synchronizing the one or more outputs and the one or more additional outputs.

3. The method of claim 1, wherein the user command is one or more of: a command to play video or audio data; a command to retrieve video or audio data; a command to initiate a connection with a server; a command to end a connection with a server; a command to modify video or audio data; a command to access a plugin; a command to apply a plugin to video or audio data; a command to change parameters for a plugin; a command to add or delete audio or video data; and a command to modify audio or video processing.

4. The method of claim 3, wherein the user command is a command to play video data and the synchronized output is one or more frames of video data.

5. The method of claim 3, wherein the user command is a command to play audio data and the synchronized output is a block of audio data comprising one or more audio samples.

6. The method of claim 5, wherein the block of audio data comprises 10 ms of audio samples.

7. The method of claim 1, wherein synchronizing the one or more outputs is performed by an audio/video multiplexor compressor.

8. The method of claim 1, wherein synchronizing the one or more outputs comprises compressing audio or video data.

9. The method of claim 1, wherein retrieving, from the identified server, one or more outputs associated with the user command comprises executing a pull action to retrieve data from the identified server.

10. The method of claim 9, wherein the pull action is executed at periodic time intervals.

11. A method for generating a thumbnail for uploaded video data, the method comprising:
receiving uploaded video data from a client device, the video data including one or more frames, each frame of the one or more frames associated with a timestamp;
responsive to receiving the uploaded video data, generating a static video image from a frame of the one or more frames, the generating comprising:
selecting a set of frames from the one or more frames, the selection performed at a first series of non-contiguous time intervals based on a length of the video data;
selecting a first subset of frames from the selected set, the first subset including frames associated with a timestamp based on a threshold amount of time from a start and end of the video data;
determining, for each frame of the first subset of frames, a bit size;
selecting a frame based on the determined bit size for each frame of the first subset of frames; and
using the selected frame for generating the static video image;
responsive to receiving the uploaded video data, generating a thumbnail video from a second subset of the one or more frames, the generating comprising:
selecting the second subset of frames from the one or more frames, the selection performed at a second series of time intervals; and
combining the selected second subset of frames to create the thumbnail video; and
storing the static video image and the thumbnail video in association with the uploaded video data.

12. The system of claim 11, wherein the threshold amount of time from the start and end of the video data is a programmable time.

13. The system of claim 12, wherein the programmable time is 20% of the length of the video data.

14. The system of claim 11, wherein selecting a frame based on the determined bit size further comprises selecting a frame associated with the greatest bit size.

15. The system of claim 11, wherein the video data is compressed.

16. The system of claim 11, wherein selecting a set of frames from the one or more frames further comprises selecting a set of ten frames.

17. The system of claim 11, wherein selecting the second subset of frames from the one or more frames further comprises selecting frames associated with 1 second time intervals of the video data.

18. A method for generating a thumbnail for uploaded audio data, the method comprising:
receiving uploaded audio data from a client device;
responsive to receiving the uploaded audio data, generating an audio thumbnail from a sampling of the audio data, the generating comprising:
identifying blocks of audio data, the blocks corresponding to a time interval;
for each block of audio data, measuring a maximum amplitude and a minimum amplitude;
storing the maximum and minimum amplitudes for each block of audio data;
based on the maximum and minimum amplitudes for each block of audio data, generating a waveform representative of the audio data;
storing the generated waveform in association with the uploaded video data for use as the audio thumbnail.

19. The system of claim 18, wherein the audio data includes a left channel and a right channel.

20. The system of claim 19, wherein generating an audio thumbnail from the sampling of audio data further comprises measuring a first maximum amplitude and a first minimum amplitude for each block of audio data of the left channel and measuring a second maximum amplitude and a second minimum amplitude for each block of audio data of the right channel.

21. The system of claim 20, wherein the measured maximum amplitudes and minimum amplitudes for the left channel and the measured maximum amplitudes and minimum amplitudes for the right channel are stored separately.
